(19) United States
(12) Patent Application Publication
(10) Pub. No.: US 2009/0149221 A1
(43) Pub. Date: Jun. 11, 2009

(54) CENTRALIZED BASE STATION SYSTEM BASED ON ADVANCED TELECOMMUNICATION COMPUTER ARCHITECTURE PLATFORM

(75) Inventors: Sheng Liu, Guangdong (CN); Shaoyun Ruan, Guangdong (CN); Baijun Zhao, Guangdong (CN)

Correspondence Address: GALLAGHER & LATHROP, A PROFESSIONAL CORPORATION, 601 CALIFORNIA ST, SUITE 1111, SAN FRANCISCO, CA, 94108, US

(73) Assignee: UTSTARCOM TELECOM CO., LTD., Hangzhou City, Zhejiang (CN)

(21) Appl. No.: 11/662,323

(22) PCT Filed: Sep. 8, 2004
(86) PCT No.: PCT/CN04/01032

§ 371 Date: May 11, 2007

(51) Int. Cl. H04M 1/00

(52) U.S. Cl. 455/561

(57) ABSTRACT

A centralized base station system based on ATCA, comprising a main base station subsystem and one or more remote radio frequency subsystems, the main base station subsystem comprising: one or more shelves based on ATCA platform, each shelf comprising at least one control switch module of ATCA board form; one or more base station controller interface module; a signaling module; one or more baseband processing modules; one or more remote radio frequency interface modules; a first switch network comprising first switch network shelf back board BASE interface link, a control switch module and a first network switch unit; a second switch network comprising a shelf back board FABRIC interface link, a control switch module and a second network switch unit; a clock synchronization network comprising a shelf back board clock synchronization bus, a control switch module and a clock unit; and a signal transmission network, wherein the second network switch unit and the clock unit are further connected to the first network switch unit, one of the control switch modules of all the shelves is the main control module.

### TECHNICAL FIELD

The present invention relates to a base station technique in a mobile communication system, in particular relates to a centralized base station architecture with radio frequency units being separated and its implementation on the ATCA (advanced telecommunication computer architecture) platform.

### BACKGROUND ART

1. The Technique Based on Remote Radio Frequency Units and the Centralized Base Station

In a mobile communication system, as shown in FIG. 1a, a wireless access network is typically composed of base stations (BTS) and a base station controller (BSC) or wireless networks controller (RNC) for controlling the base stations. As shown in FIG. 1b, a base station is mainly composed by a baseband processing subsystem, a radio frequency (RF) subsystem, antennas and etc., and performs transmission, reception and processing of wireless signals, and the base station may cover different cells through a plurality of antennas.

In the mobile communication system, there are wireless network coverage problems that are more difficult to solve with conventional BTS technology, such as indoor coverage of high-rise buildings, coverage hole, or the coverage of shadow zone. A technique based on remote radio frequency units is a more effective solution being proposed to solve the above problems. In the base station system based on remote radio frequency units, radio frequency units and antennas are installed in regions where it is required to provide a coverage, and are connected to other units in the base station through wideband transmission lines.

The technique is further developed as the technique of centralized base station based on remote radio frequency units. As compared to the conventional base station, such a centralized base station based on radio frequency units has many advantages: Allowing to replace one macro cell based on the conventional base station with a plurality of micro cells, thereby best accommodating different wireless environments and increasing wireless performances such as capacity, coverage and etc. of the system; The centralized structure makes it possible to perform soft handoff in the conventional base station by softer handoff, thereby obtaining an additional processing gain; And the centralized structure also makes it possible to use costly baseband signal processing resources as a resource pool shared by a plurality of cells, thereby obtaining benefits of statistical multiplexing and reduced system cost. More implementation details of this technique are disclosed in U.S. Pat. No. 5,657,374 “Cellular system with centralized base stations and distributed antenna units” and U.S. Pat. No. 6,324,391 “Method and system for cellular communication with centralized control and signal processing”.

As shown in FIG. 2, the centralized base station system 10 based on remote radio frequency units are composed of a central channel processing subsystem 11 and remote radio frequency units (RRU) 13 which are centrally configured and connected through the wideband transmission link or network 12. The central channel processing subsystem 11 is mainly composed by functional units such as a channel processing resource pool 15, a BSC/RNC interface unit 14, a signal routing distribution unit 16 and etc. The channel processing resource pool 15 is formed by stacking a plurality of channel processing units 1-N, and performs operations such as baseband signal processing and etc. The signal routing distribution unit 16 dynamically allocates channel processing resources according to the traffic of different cells to realize effective sharing of the processing resources among multiple cells. Besides the implementation inside the centralized base station as shown in FIG. 2, the signal routing distribution unit 16 may also be implemented as a separate device outside the centralized base station. The remote antenna element 13 is mainly constituted by units such as the transmission channel's radio frequency power amplifier, the reception channel's low noise amplifier, antennas and etc. For the link between the central channel processing subsystem (also called as main unit (MU) hereafter) and a remote radio frequency unit (RRU), it is typically possible to employ transmission medium such as optical fiber, coaxial cable, microwave and etc. As a particular example, the remote radio frequency unit may be located locally at the central channel processing subsystem, wherein the connection between the radio frequency unit and the signal routing distribution unit may be suitable only to local transmission.

The technique based on remote radio frequency units can provide benefits such as centralized management, processing resource sharing and etc. It permits the number of cell (or coverage area) supported by a single base station and the amount of processing resources as included far beyond the level that a conventional base station can reach.

According to the original intention for designing the centralized base station system, it is desirable that all the baseband processing resources in the entire base station system can be shared by as much as possible remote radio frequency units, to achieve a maximal statistical multiplexing. However, in the existing centralized base station system, its interconnection architecture restricts such sharing optimization. For example, in the prior art, the following connection manners are employed:

1) Binding the baseband processing resources and the remote radio frequency units together, such that the baseband processing resource only serve the bound remote radio frequency unit. This is apparently not optimal.

2) Establishing physical connections between the baseband processing resources and the remote radio frequency units according to fixed correspondence (such as one to one). An extreme case is to apply a physical all-interconnecting (Mesh) connection relation between the baseband processing resources and the remote radio frequency unit. But this manner is only applicable to small base station, and still belongs to the above binding manner in substance, nothing but implementing the binding through physical connections. The cost of all-interconnecting is very high, and cannot be implemented when the base station is larger. Furthermore, reducing the interconnecting degree cannot achieve the optimal sharing. In addition, changing correspondence needs adjusting physical connections, causing high maintenance complexity and cost.

3) The manner in which the baseband processing resource and the remote radio frequency unit are coupled into a centralized combiner/distributor apparatus. In similar to all the centralized processing structure, such centralized combiner/distributor apparatus has a problem where its underlying configuration is relatively fixed, but lacks scalability, cannot accommodate the change in the system scale flexibly, and when the system scale is larger, its processing band width becomes a bottleneck. Therefore, it does not comply with original intention for designing the centralized base station system.

It is common for these interconnecting manners that once the connection relation changes, a very large amount of operations need to be done to adjust the system, especially when the system scale is larger, and the interconnecting relation is complex.

In case that it is impossible to provide an all-interconnecting architecture with proper cost and performance, even if increasing the system scale, since it is unable to achieve effective interconnecting and sharing, its profit is not in proportion to the investment for increased scale.

It is very difficult for the existing system to be modularized, for example, it is very difficult to perform incremental integration in units of shelves, because when adding a new module (shelf), such architecture cannot effectively achieve cross-module all-interconnecting, and the cross-shelf interconnecting needs many and complex configuration (such as wiring and setting) operations. Accordingly, if the system scale largely changes over time, it is very difficult to custom the system to accommodate such change during the early construction and later maintenance. Therefore it lacks scalability, flexibility and maintainability.

In the hardware platform aspect, since the interconnecting manner of the prior art limits the flexibility in component distribution and configuration, when considering the size, heat dispersing and etc. of the radio frequency power device, the base station hardware platform often employ the platform defined by the vendor. For example, since the limitation in connection manner, it is unable to reasonably extract out component with less requirements on size, heat dispersing and etc. to use a general hardware platform.

Interconnecting between the baseband processing resources and the base station controller also has the similar problem.

In sum, the interconnecting architecture in the centralized base station system has become a critical factor which restricts the development of the centralized base station system.

With respect to these problems, the same applicant proposes a base station architecture having a structure as shown in FIGS. 3a and 3b in a patent application entitled “extensible architecture of a centralized base station system”, where the radio frequency section is separated from the baseband processing resources. It facilitates to support multiple shelf extension between the baseband processing resources and radio frequency transmitting and receiving units (or remote radio frequency unit interface module), and between the baseband processing resources and the base station controller interface module, thereby supporting high-capacity requirement of the base station based on remote radio frequency units, supporting sharing and dynamic allocation of processing resources, and facilitating to support optimal system configuration.

In the base station architecture as shown in FIGS. 3a and 3b, base station controller interface unit 26 provides a transmission interface from the base station to the base station controller. Signaling unit 18 perform protocol processing required by the signaling transmission between the base station and the base station controller. LAN switch network 28 is a transmission carrying network for internal control signals, management instructions and signaling, and the user data flows between the base station controller interface unit and the baseband processing units. Baseband processing unit 24 performs function of the baseband processing portion in the wireless protocol physical layer procedure. Baseband signal switch network 27 is used for the exchange of baseband data flows between baseband processing module 24 and radio frequency units 32 or remote radio frequency interface modules 25. Remote radio frequency interface unit 25 provides the interface between main base station subsystem 21 and remote radio frequency subsystem 22 through a proper remote signal transmission method. Main control unit 29 is in charge of system management, monitoring, maintenance, resource management and etc. of the entire base station. Clock synchronization unit 23 generates various timing signals required by respective modules in the system by tracking GPS, BITS or synchronization reference signals sent from the base station controller.

2. ATCA (Advanced Telecommunication Computer Architecture)

CompactPCI architecture has been widely used in the fields of telecommunication and computer. However, with developing of the technique and increasing application requirements, applications in telecommunication field have more requirements on single board processing density, single board area, power consumption, throughput, system management, reliability and etc. Although some extension has been made for CompactPCI architecture, it is still difficult to meet the increasing requirement, and it is also difficult to employ new techniques such as high speed differential transmission technique. In this case, PICMG begins to develop a new generation advanced telecommunication computer architecture, i.e., ATCA.

The core specification PICMG3.0 in ATCA specification family defines mechanical structure, power source, heat dispersing, interconnection, system management portions of ATCA architecture, and some other auxiliary specifications define transmitting manners of interconnection in the core specification.

In the single board size aspect, the ATCA specification is front board 8 U (high)×280 mm (deep), rear board 8 U×70 mm. The pitch between slots is 1.2″, a 19″ shelf can support 14 slots, and 600 mm ETSI shelf can support 16 slots. Compared to 6 U×160 mm single board size and 0.8″ slot pitch of CPCI, the circuit number as accommodated, the device height as supported, the max power consumption of single board and etc. in a ATCA single board are considerably increased, and wider board also enhances the support to connected and plugged devices.

In the power source aspect, each ATCA single board receives direct power supply of two-way independent −48VDC power source, increasing power supply reliability and power supply ability. The power supply on each single board is divided into management power supply portion and load power supply portion. The management power supply has smaller power, dedicated for power supply of controller (IPMC) 42 for platform management on the board. Under control of the controller, the power source module on the board can provide power to other loads or cut off the power supply to other loads.

The shelf management of the ATCA is based on serial management bus 40 of the IPMB, the IPMC on each single board has two independent IPMB buses which are primary and secondary for each other (one called as IPMB-A, another called as IMPB-B), and is connected to shelf management controller (ShMC) 41. The management connection between the single board and the shelf management controller may be bus type or star type. The physical layer of the IPMB is very concise I²C serial signal line, and the redundancy of system management bus further enhances reliability of management channels. Please see FIG. 4.

In the single board interconnection aspect, the ATCA defines clock synchronization bus 43, Update channel 44, Base interface 45, Fabric interface 46, and IPMB bus 47 at the bottom in the order from top to bottom. Please see FIG. 5 (vertical and long blocks denote plug boards or their slots). Update channel 44 is used for direct connection between single boards that need direct data transmission of very high speed and large throughput or real time interaction therebetween. The connections of the Update channels on the back boards are very flexible, and the connection as shown is only an example. Base interface 45 is of Dual Star type topology structure having links of 10/100/1000Base-T, and the center of the star is a redundant single switch board. Fabric interface 46 is used for high speed data transmission between single boards, Fabric interface 46 is based on SERDES signal up to 3.125 Gbps and may support 10 Gb transmission rate in the star type and all-mesh interconnections. Fabric interface 46 may support various transmission specifications, and when adopting the star type topology, the center of the star is also a redundant single switch board. The board arrangement and connecting lines in FIG. 5 are only schematic, and in fact the Fabric network can support various topologies such as Dual Star, all-interconnection and etc. The slot arrangement, including that of switch boards, is also flexible.

The ATCA fully eliminates the PCI bus structure, and the data transmission between boards and between a single board and a switch board both adopt point to point high speed differential link technique. The interconnection reliability is increased, and the throughput ability of the hardware platform is considerably increased.

The ATCA architecture has been supported by many main software and hardware manufacturers, and will became a widely-used platform architecture standard of telecommunication devices.

When implementing a high-capacity, high reliable wireless communication base station, the ATCA architecture is very suitable. At the same time, because the ATCA is a general platform architecture being widely supported, adopting the architecture may also produce the benefits such as reduced cost, shorten development cycle, ease to be supported and etc.

3. Origination of the Invention

Since its advantages in architecture, the ATCA platform can best meet requirements of a high-capacity base station system for single board processing capacity, interconnection band width between boards, power supply, heat-dispersing, reliability, management and etc. All these features are suitable to implement the extensible architecture of centralized base station system proposed by the present applicant, and therefore, the present invention proposes a ATCA platform-based centralized base station architecture with radio frequency units being separated.

### SUMMARY OF THE INVENTION

According to one aspect of the present invention, there is provided a centralized base station system based on advanced telecommunication computer architecture ATCA including a main base station subsystem and one or more remote radio frequency subsystems, said remote radio frequency subsystem being in charge of signal reception and transmission of respective cells, said main base station subsystem comprising: one or more shelves based on ATCA platform, each shelf comprising at least one control switch module of ATCA board form; one or more base station controller interface modules in form of ATCA boards inserted into the shelves, for providing transmission interfaces with the base station controller for the base station system; a signaling module in form of a ATCA board inserted into the shelf, for performing protocol processing required by the signaling transmission between the base station system and the base station controller, so as to provide processing support for said base station controller interface unit; one or more baseband processing modules in form of ATCA boards inserted into the shelves, for performing baseband processing of wireless protocol physical layer procedure to uplink wireless signals from the cells and a downlink user data flow from the base station controller; one or more remote radio frequency interface modules in form of ATCA boards inserted into the shelves, for providing interfaces with the remote radio frequency subsystems for the main base station subsystem; a first switch network comprising shelf back board BASE interface links, said control switch modules and a first network switch unit, wherein the modules of said base station controller interface module, signaling module, baseband processing module and remote radio frequency interface module in the same shelf are connected to the control switch module through the shelf back board BASE interface links, the control switch module provides data exchange within the shelf, the control switch modules within the respective shelves are connected to the first network switch unit, and the first network switch unit provides data exchange between the shelves; a second switch network comprising shelf back board FABRIC interface links, said control switch modules and a second network switch unit, wherein the modules of said baseband processing module and remote radio frequency interface module in the same shelf are connected to the control switch module through the shelf back board FABRIC interface links, the control switch module provides baseband signal flow exchange within the shelf, the control switch modules within the respective shelves are connected to the second network switch unit, and the second network switch unit provides baseband signal flow exchange between the shelves; a clock synchronization network comprising a shelf back board clock synchronization bus, said control switch module and a clock unit, wherein the clock unit is used for obtaining a reference clock and providing a clock synchronization signal to the control switch modules of the respective shelves, the control switch module provides the clock synchronization signal to the respective modules in the same shelf through the shelf back board clock synchronization bus; and a signal transmission network for transmitting baseband signal flows between the remote radio frequency interface modules and the remote radio frequency subsystems, Wherein said second network switch unit and clock unit are further connected to the first network switch unit so as to be connected to the first switch network, and said control switch module is in charge of controlling respective portions in the same shelf, and wherein one of the control switch modules of all the shelves is a main control module in charge of controlling the control switch modules within other shelves and other components outside the shelves within the system through the first switch network.

In an embodiment, The shelf back board BASE interface links are 10/100/1000 base-T.

In another embodiment, The shelf back board FABRIC interface links are SERDES links.

In another embodiment, The first network switch unit is in form of ATCA board inserted into the shelf.

In another embodiment, The second network switch unit is in form of ATCA board inserted into the shelf.

In another embodiment, The clock unit is in form of ATCA board inserted into the shelf.

In another embodiment, The control switch module and the second network switch unit are interconnected via a high speed differential signal cable or optical fiber.

In another embodiment, In one shelf, the control switch module, the base station controller interface module, the baseband processing modules and the remote radio frequency interface modules have respective additional backup modules.

In another embodiment, The clock unit is implemented by a redundantly configured clock integrated function block which is replaceable.

In another embodiment, The first network switch unit or the second network switch unit has a redundant configuration.

In another embodiment, When the shelf where the main control module is located fails, its work is taken over by the control module of another shelf according to a predetermined mechanism.

In another embodiment, More than one baseband processing units process one baseband signal flow or user data flow in a load-sharing manner.

In another embodiment, The clock unit generates the timing signal by tracking GPS, BITS or the synchronization reference signal from the base station controller via the base station controller interface module.

In another embodiment, The base station controller interface module performs the transport layer function of the interface between the base station system and the base station controller.

In another embodiment, Said transport layer function is AAL, ATM, IMA, SDH, E1 or T1.

In another embodiment, In the downlink direction, the base station controller interface module separates a signaling flow and user data flows from the downlink data flow, and transmits them to the signaling module and respective baseband processing modules through the first switch network; in the uplink direction, the base station controller interface module multiplexes a signaling flow and user data flows from the respective baseband processing modules into the uplink data flow.

In another embodiment, The base station controller interface module performs protocol format transformation of data flows between the transmission with the base station controller and the exchange with internal modules of the base station system.

In another embodiment, The exchange with the internal modules by the base station controller interface module adopts the network switch technique based on IP/Ethernet, the data transmission with the base station controller adopts UDP or TCP, and the protocol format transformation adopts UDP/IP/Ethernet or TCP/IP/Ethernet protocol stack.

In another embodiment, The base station controller interface module performs collection/distribution of the user data flows.

In another embodiment, The base station controller interface module performs synchronization extracting.

In another embodiment, In the uplink direction, according to a task allocation policy, the main control module specifies so that a baseband sampling signal flow of any one cell is switched to any one baseband processing module for processing, or is copied to a plurality of baseband processing modules for processing; in the downlink direction, according to the task allocation policy, the main control module specifies so that a user data flow of any one cell is switched to any one baseband processing module for processing, or is copied to a plurality of baseband processing modules for processing.

In another embodiment, each baseband processing unit is able to process one to multiple baseband data flows at the same time.

In another embodiment, the signal transmission network adopts a cross interconnection device that can be controlled by the main control module.

According to another aspect of the present invention, there is provided a centralized base station system based on advanced telecommunication computer architecture ATCA including a main base station subsystem and one or more remote radio frequency subsystems, said remote radio frequency subsystem being in charge of signal reception and transmission of respective cells, said main base station subsystem comprising: one or more shelves based on ATCA platform, each shelf comprising at least one control module of ATCA board form; one or more base station controller interface modules in form of ATCA boards inserted into the shelves, for providing transmission interfaces with the base station controller for the base station system; a signaling module in form of a ATCA board inserted into the shelf, for performing protocol processing required by the signaling transmission between the base station system and the base station controller, so as to provide processing support for said base station controller interface unit; one or more baseband processing modules in form of ATCA boards inserted into the shelves, for performing baseband processing of wireless protocol physical layer procedure to uplink wireless signals from the cells and a downlink user data flow from the base station controller; one or more remote radio frequency interface modules in form of ATCA boards inserted into the shelves, for providing interfaces with the remote radio frequency subsystems for the main base station subsystem; a first switch network comprising shelf back board BASE interface links, first network switch modules and a first network switch unit, wherein the modules of said control module, base station controller interface module, signaling module, baseband processing module and remote radio frequency interface module in the same shelf are connected to the first network switch module through the shelf back board BASE interface links, the first network switch module provides data exchange within the shelf, the first network switch modules within the respective shelves are connected to the first network switch unit, and the first network switch unit provides data exchange between the shelves; a second switch network comprising shelf back board FABRIC interface links, second network switch modules and a second network switch unit, wherein the modules of said baseband processing module and remote radio frequency interface module in the same shelf are connected to the second network switch module through the shelf back board FABRIC interface links, the second network switch module provides baseband signal flow exchange within the shelf, the second network switch modules within the respective shelves are connected to the second network switch unit, and the second network switch unit provides baseband signal flow exchange between the shelves; a clock synchronization network comprising a shelf back board clock synchronization bus, clock allocation modules and a clock unit, wherein the clock unit is used for obtaining a reference clock and providing a clock synchronization signal to the clock allocation modules of the respective shelves, the clock allocation module provides the clock synchronization signal to the respective modules in the same shelf through the shelf back board clock synchronization bus; and a signal transmission network for transmitting baseband signal flows between the remote radio frequency interface modules and the remote radio frequency subsystems, wherein said second network switch unit and clock unit are further connected to the first network switch unit, in order to be connected to the first switch network, said first network switch module, second network switch module and clock allocation module are in form of ATCA boards inserted into the shelves, and are connected to the first network switch module in the same shelf through the shelf back board BASE interface link, and said control module is in charge of controlling respective portions in the same shelf, and one of the control switch modules of all the shelves is a main control module in charge of controlling the control modules within other shelves and other components outside the shelves within the system through the first switch network.

In an embodiment, in one shelf, the control module, the clock allocation module, the base station controller interface module, the baseband processing modules, the remote radio frequency interface modules, the first network switch module or second network switch module have respective additional backup modules or units.

According to another aspect of the present invention, there is provided a centralized base station system based on advanced telecommunication computer architecture ATCA, comprising: one or more shelves based on ATCA platform, each shelf comprising at least one control switch module of ATCA board form; one or more radio frequency modules in form of ATCA boards inserted into the shelves, being in charge of signal reception and transmission of respective cells; one or more base station controller interface modules in form of ATCA boards inserted into the shelves, for providing transmission interfaces with the base station controller for the base station system; a signaling module in form of a ATCA board inserted into the shelf, for performing protocol processing required by the signaling transmission between the base station system and the base station controller, so as to provide processing support for said base station controller interface unit; one or more baseband processing modules in form of ATCA boards inserted into the shelves, for performing baseband processing of wireless protocol physical layer procedure to uplink wireless signals from the cells and a downlink user data flow from the base station controller; a first switch network comprising shelf back board BASE interface links, said control switch modules and a first network switch unit, wherein the modules of said base station controller interface module, signaling module, baseband processing module and radio frequency module in the same shelf are connected to the control switch module through the shelf back board BASE interface links, the control switch module provides data exchange within the shelf, the control switch modules within the respective shelves are connected to the first network switch unit, and the first network switch unit provides data exchange between the shelves; a second switch network comprising shelf back board FABRIC interface links, said control switch modules and a second network switch unit, wherein the modules of said baseband processing module and radio frequency module in the same shelf are connected to the control switch module through the shelf back board FABRIC interface links, the control switch module provides baseband signal flow exchange within the shelf, the control switch modules within the respective shelves are connected to the second network switch unit, and the second network switch unit provides baseband signal flow exchange between the shelves; a clock synchronization network comprising a shelf back board clock synchronization bus, said control switch module and a clock unit, wherein the clock unit is used for obtaining a reference clock and providing a clock synchronization signal to the control switch modules of the respective shelves, the control switch module provides the clock synchronization signal to the respective modules in the same shelf through the shelf back board clock synchronization bus, wherein said second network switch unit and clock unit are further connected to the first network switch unit, in order to be connected to the first switch network, said control switch module is in charge of controlling respective portions in the same shelf, and one of the control switch modules of all the shelves is a main control module in charge of controlling the control switch modules within other shelves and other components outside the shelves within the system through the first switch network.

According to another aspect of the present invention, there is provided a centralized base station system based on advanced telecommunication computer architecture ATCA, comprising: one or more shelves based on ATCA platform, each shelf comprising at least one control module of ATCA board form; one or more radio frequency modules in form of ATCA boards inserted into the shelves, being in charge of signal reception and transmission of respective cells; one or more base station controller interface modules in form of ATCA boards inserted into the shelves, for providing transmission interfaces with the base station controller for the base station system; a signaling module in form of a ATCA board inserted into the shelf, for performing protocol processing required by the signaling transmission between the base station system and the base station controller, so as to provide processing support for said base station controller interface unit; one or more baseband processing modules in form of ATCA boards inserted into the shelves, for performing baseband processing of wireless protocol physical layer procedure to uplink wireless signals from the cells and a downlink user data flow from the base station controller; a first switch network comprising shelf back board BASE interface links, first network switch modules and a first network switch unit, wherein the modules of said control module, base station controller interface module, signaling module, baseband processing module and radio frequency module in the same shelf are connected to the first network switch module through the shelf back board BASE interface links, the first network switch module provides data exchange within the shelf, the first network switch modules within the respective shelves are connected to the first network switch unit, and the first network switch unit provides data exchange between the shelves; a second switch network comprising shelf back board FABRIC interface links, second network switch modules and a second network switch unit, wherein the modules of said baseband processing module and radio frequency module in the same shelf are connected to the second network switch module through the shelf back board FABRIC interface links, the second network switch module provides baseband signal flow exchange within the shelf, the second network switch modules within the respective shelves are connected to the second network switch unit, and the second network switch unit provides baseband signal flow exchange between the shelves; a clock synchronization network comprising a shelf back board clock synchronization bus, clock allocation modules and a clock unit, wherein the clock unit is used for obtaining a reference clock and providing a clock synchronization signal to the clock allocation modules of the respective shelves, the clock allocation module provides the clock synchronization signal to the respective modules in the same shelf through the shelf back board clock synchronization bus, wherein said second network switch unit and clock unit are further connected to the first network switch unit, in order to be connected to the first switch network, said first network switch module, second network switch module and clock allocation module are in form of ATCA boards inserted into the shelves, and are connected to the first network switch module in the same shelf through the shelf back board BASE interface link, and said control module is in charge of controlling respective portions in the same shelf, and one of the control switch modules of all the shelves is a main control module in charge of controlling the control modules within other shelves and other components outside the shelves within the system through the first switch network.

In the base station system structure according to the present invention, by adopting the Ethernet dual star link provided by the ATCA BASE interface as user data flow transmission carrier between the base station controller interface module and the baseband processing module, and adopting the high speed serial dual star link provided by the ATCA FABRIC interface to meet requirements of high speed and high throughput required by baseband data flow transmission between the baseband processing module and the remote radio frequency interface module, and between the baseband processing module and the local radio frequency module, usability of the system is increased. By taking advantage of large area of the ATCA single board, the Ethernet switch function of BASE interface, the baseband data flow switch function of FABRIC interface and the clock distribution function are integrated in one hardware module, reducing the types of modules and saving the slots of shelves. The larger single board area also allows a single baseband processing module to accommodate more processing resources.

### DESCRIPTION OF THE DRAWINGS

The features and advantages of the present invention will be further understood in view of the following description by referring to the accompanying figures, wherein:

FIG. 1a illustrates the structure of a wireless access network;

FIG. 1b illustrates the structure of a conventional base station;

FIG. 2 is a block diagram showing the structure of a centralized base station system based on remote radio frequency units;

FIG. 3a is a block diagram showing an example of extensible architecture of a centralized base station system;

FIG. 3b is a block diagram showing another example of extensible architecture of the centralized base station system;

FIG. 4 is a schematic diagram showing the ATCA shelf underlying management;

FIG. 5 is a schematic diagram showing the ATCA back boards and the module interconnection;

FIG. 6 is a schematic diagram illustrating one embodiment of the present invention;

FIG. 7 is a schematic diagram illustrating the coverage of a LAN switch network;

FIG. 8 is a schematic diagram illustrating the coverage of a baseband I/Q signal flow switch network;

FIG. 9 is a schematic diagram illustrating the coverage of a clock synchronization network;

FIG. 10 is a schematic diagram illustrating the management channel;

FIG. 11 is a block diagram showing the structure of a BCI module;

FIG. 12 is a block diagram showing the structure of a BB module;

FIG. 13 is a block diagram showing the structure of a RRI module;

FIG. 14 is a block diagram showing the structure of a FABRIC module;

FIG. 15 is a block diagram showing the structure of a TDM switch mechanism;

FIG. 16a is a schematic diagram illustrating the structure of a TDM frame;

FIG. 16b is a schematic diagram illustrating the mapping from I/Q to TDM frame;

FIG. 17 is a block diagram illustrating the structure of a NBP module;

FIG. 18 is a block diagram illustrating the structure of a ShMC module; and

FIG. 19 is a block diagram illustrating the structure of a clock unit.

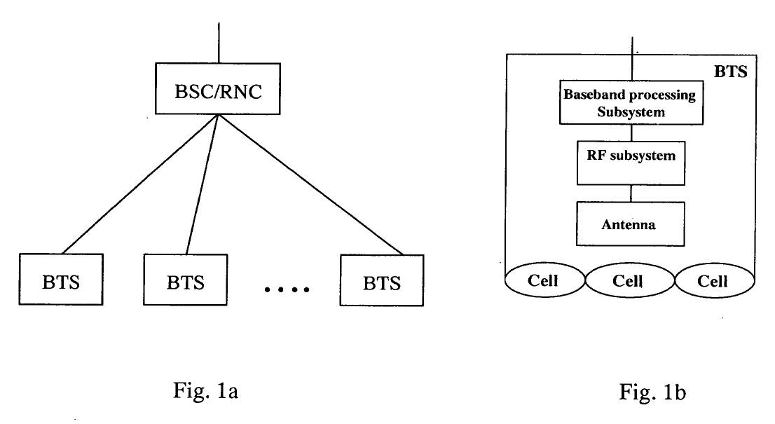

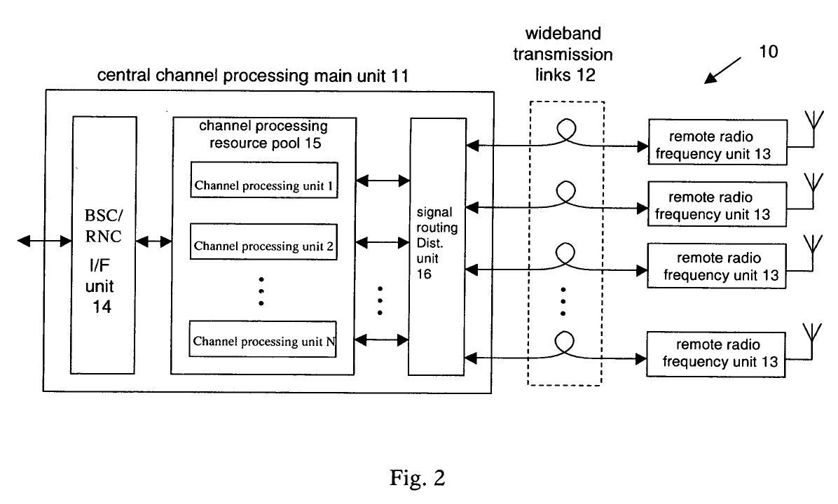

### ABBREVIATIONS

AAL: ATM adaptation layer

ALCAP: Access link control application portion

ASIC: Application-specific integrated circuit

ATCA: Advanced telecommunication computer architecture (developed by vendors such as Intel and etc.)

BB: Baseband processing module

BCI: Base station controller interface

BTS: Base station

BSC: Base station controller

CML: Current mode logic

CPCI: CompactPCI, a hardware platform architecture based on PCI bus defined by the PICMG

FPGA: Field programmable gate array

I²C Bus: Inter-integrated circuit bus

IMA: Inverse multiplex of ATM

IPMB: Intelligent platform management bus

IPMC: Intelligent platform management controller

Iub: Interface between wireless network controller (RNC) and base station (NodeB)

LAN: Local area network

LVDS: Low voltage differential signal

NBP: NodeB signaling processing module

NBAP: NodeB application portion

PICMG: PCI industrial computer manufacture group

QoS: Quality of service

RNC: Wireless network controller

RRI: Remote wireless unit interface

SDH: Synchronous digital hierarchy

ShMC: Shelf management controller

Spanning Tree Ethernet generating tree protocol

TDM: Time division multiplexing

UMTS: Global mobile telecommunication system

VLAN: Virtual LAN

### DETAILED DESCRIPTION OF THE PREFERRED EMBODIMENTS

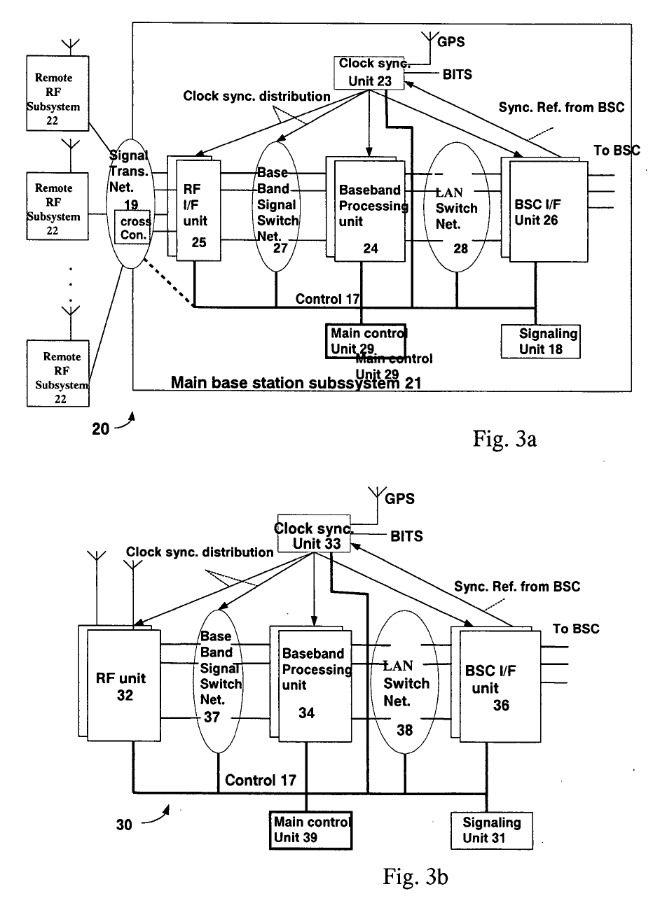

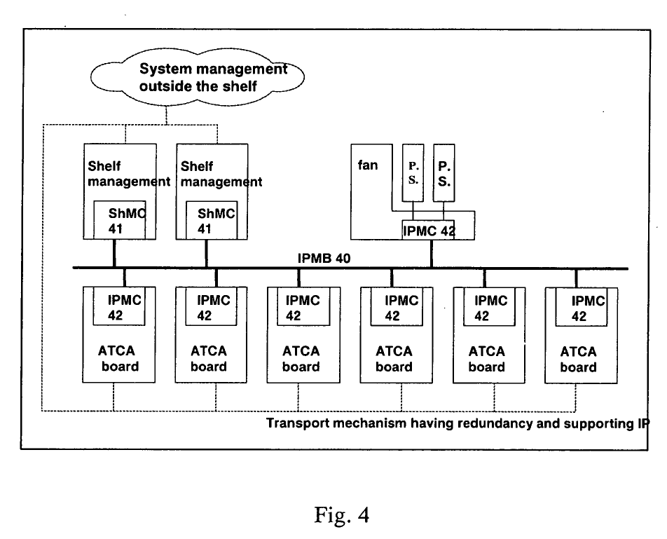

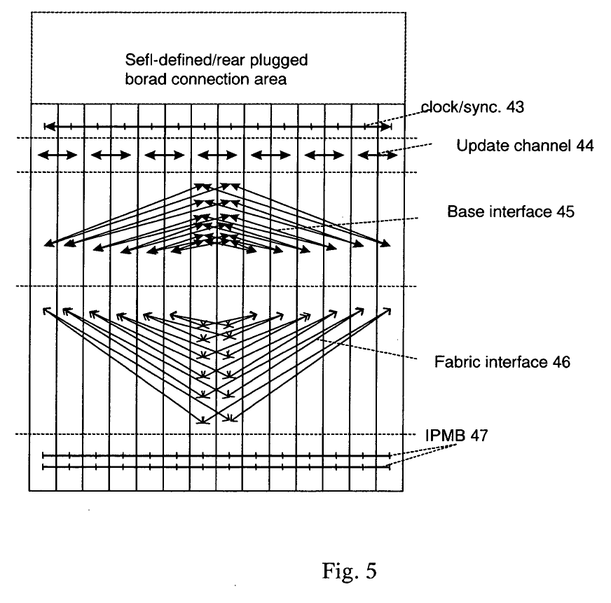

FIG. 3a is a block diagram showing the structure of centralized base station system 20 based on remote radio frequency units having an extensible architecture.

As shown in FIG. 3a, the base station system 20 comprising a main base station subsystem 21 and a plurality of remote radio frequency subsystems 22. The main base station subsystem 21 comprising a signal transmission network 19, a plurality of remote radio frequency interface units 25, a baseband signal flow switch network 27, a plurality of baseband processing units 24, a clock synchronization unit 23, a LAN (local area network) switch network 28, a base station controller interface unit 26, a main control unit 29 and a signaling unit 18. The main control unit 29 controls the other respective portions of the main base station subsystem 21 within the same shelf through a channel 17 (as shown with thick solid line), and the channel 17 may be implemented physically through LAN network or internal bus (such as PCI bus). Although the LAN switch network 28 as shown is a local area network such as Ethernet, it may also be a network based on other techniques. The remote radio frequency subsystem 22 and remote radio frequency interface unit 25 exchange uplink and downlink wireless signals through the signal transmission network 19. The remote radio frequency interface unit 19 and the baseband processing unit 24 exchange baseband signal flows through the baseband signal flow switch network 27, and the baseband processing unit 24 and the base station controller interface unit 26 exchange user and control data flows through the LAN switch network 28. The base station controller interface unit 26 is connected to the base station controller or wireless networks controller (not shown). Although not specifically shown in the figure, the main control unit 29, signaling unit 18, remote radio frequency interface unit 25 and clock synchronization unit 23 are all connected to the LAN switch network 28 through their respective interfaces (not shown), and such interface may be internal bus or dedicated connection.

Although the respective main portions of the centralized base station system are shown in a centralized way, these portions may be physically located in different shelves respectively, and units in different shelves may be connected through a switch network. The interconnection structure based on switch network facilitates to add and remove system components, to modify configuration, and interconnection cross the shelves.

The respective aspects of the centralized base station system 20 will be described in detail in the following.

Base Station Controller Interface Unit

The base station controller interface unit 26 provides a transmission interface from the base station system 20 to the base station controller, and its main functions include:

(1) Performing transport layer function (such as AAL, ATM, IMA, SDH, E1, T_and etc.) between the base station system 20 and the base station controller.

(2) Separating the signaling flow, OAM flow and user data flows from the downlink data flow, and respectively transmitting them to corresponding internal units through the LAN switch network 28, for example, transmitting the user data flows to the corresponding baseband processing units 24 through the LAN switch network 28, and transmitting the signaling flow to the signaling unit 18 through the LAN switch network 28; in the uplink direction, multiplexing the signaling flow and user data flows from the respective internal units into the uplink data flow.

(3) Performing user data flow protocol processing such as FP protocol processing of Iub in UMTS.

(4) Performing protocol format transformation of data flow between the transmission with the base station controller and the exchange with the internal units, for example, when the exchange with the internal units adopts a network switch technique based on IP/Ethernet and the data transmission with the base station controller adopts UDP or TCP, the data flow transmission adopts UDP/IP/Ethernet or TCP/IP/Ethernet protocol stack.

(5) Performing collection/distribution of the user data flows. In the downlink direction, the user data flows are distributed to the respective baseband processing units 24 for processing the data flows.

(6) Performing synchronization extracting, wherein as required, the base station controller interface module 40 may extract the timing reference signal from a specified transmission line which is transmitted from the base station controller and transmit it to the clock synchronization unit 23 of the system.

Signaling Unit

The signaling unit 18 performs protocol processing required by the signaling transmission between the base station system 20 and the base station system 20 controller. By taking UMTS as an example, the signaling unit 18 performs processing of NBAP, ALCAP protocols. The signaling flow to be processed by the signaling unit 18 is obtained by the data flow separating function of the base station controller interface unit 26. According to the designed capacity, the unit may comprise one to multiple signaling processing modules.

LAN Switch Network

The LAN switch network 28 adopts IP/Ethernet technique. The IP/Ethernet technique is a typical local area network technique suitable to exchanging internal control signal, management signal, signaling, and user data flows between the base station controller interface unit and the baseband processing units. Other suitable LAN techniques such as FDDI and so on may also be applicable to construct a LAN switch network. The LAN switch network 28 is able to perform flexible configuration, such as VLAN configuration, QoS configuration under control of the system's main control module 29, and is able to perform the required data flow forwarding and statistic function.

Baseband Processing Unit

The baseband processing unit 24 performs function of the baseband processing portion in the wireless protocol physical layer procedure. By taking UMTS as an example, in the downlink direction, according to the specification by a task allocation policy, the baseband processing unit 24 receives respective user data flows from the base station controller interface unit 26 through the LAN switch network 28, performs processed such as channel encoding, interleaving, rate adaptation, spreading, scrambling, modulating and etc., forms baseband I/Q signal flows and transmits them to respective remote radio frequency subsystems 22 through the remote radio frequency interface unit 25. In the uplink direction, according to the specification of a task allocation policy by the main control unit 29, the baseband processing unit 24 receives I/Q sampling signal flows from respective remote radio frequency subsystems 22 through the remote radio frequency interface unit 25 (usually, 2˜8 times chip rate sampling), obtains user data flows through processing such as matching filtering, despreading, channel estimation, RAKE merging, signal-interference ratio (SIR) estimation, de-interleaving, channel decoding and etc., and transmits them to the base station controller interface unit 26 through the LAN switch network 28 for forwarding. At the same time, a fast power control function needs to be performed in cooperation between the uplink and downlink processing.

The baseband processing unit 24 may adopt a scheme where the chip level processing (spreading, scrambling and etc.) and the symbol level processing (channel coding and decoding, rate adaptation and etc.) are integrated in the same hardware module, and may also adopt a scheme where these two functions are implemented through separate hardware modules. When adopting the separating scheme, the data flow transmission between the chip level processing module and the symbol level processing module is performed through the LAN switch network 28.

There may be multiple baseband processing units 24, and each baseband processing unit 24 may process one to multiple baseband I/Q signal flows. Each baseband processing unit 24 has a control channel to the system's main control unit 29 for receiving and performing the resource management instruction. In the present example, the connection between the baseband processing unit 24 and the main control unit 29 is established through the LAN switch network 28. Thus, by using the good scalability and block-free exchanging ability of the LAN switch network 28, there is provided a means for interconnecting the units in the system, especially the units not suitable to implement a widespread interconnection through a tight-coupling channel such as bus or a point to point channel such as RS232 (for example, when the baseband processing units and the main control unit are not within the same shelf, i.e., are not on the same board).

Baseband Signal Flow Switch Network

The baseband signal flow switch network 27 is used for exchanging of baseband signal flows between the baseband processing modules 24 and the remote radio frequency interface units 25.

Since adopting a block-free (or low block) switch network structure, in the uplink direction, according to the specification by the main control unit 29 based on a task allocation policy, the baseband sampling signal flow of any one cell (antenna) may be exchanged to any one baseband processing unit 24 for processing, and it is also possible to transmit multiple copies of one uplink signal flow to multiple baseband processing units 24 for processing (each unit may process a respective different channel); in the downlink direction, the downlink channels of the same cell may be processed on multiple baseband processing units 24 and then be combined. Therefore, by using such structure based on baseband signal flow switch network 27, it is possible to support on-demand dynamic allocation of baseband processing resources, facilitating to increase utilization of the baseband processing resources. In similar to the LAN switch network 28, there is also provided a means for interconnecting the units within the system, especially the units not suitable to implement a widespread interconnection through a tight-coupling channel such as bus or a point to point channel (for example, when the baseband processing units and the remote radio frequency interface units are physical distributed in different shelves).

Since the data rate obtained after the baseband processing unit processing in the downlink direction and the data rate before the baseband processing in the uplink direction is relatively higher, the back board wiring between the baseband signal flow switch network and the relevant modules adopts LVDS, CML or other high speed differential signal serial transmission technique. The wiring between shelves adopts high speed differential pair cable or optical fiber connection. The differential line pair, the differential pair cable or the optical fiber may support the case where a single signal is a physical transmission port, and may also support a case where multiple serial signals are combined into one physical transmission port. Over the physical layer of the high speed differential line pair, it is possible carry a simple time division multiplexing frame structure, and it is also possible to carry a upper layer protocol such as Ethernet, IP and etc. When employing one differential pair of 3 Gbps CML technique as a physical port and employing a simple time division multiplexing frame structure and 8B/10B line encoding, each way may multiplex up to 20 or more I/Q signal flows. There may be one or more physical transmission ports from each module slot to the baseband signal flow switch network.

Since the application of functions such as fast power control and etc. on the wireless interface, the transmission latency between the baseband processing units and the radio frequency units needs a more rigid control, and therefore the baseband signal flow switch network is preferably designed as a high speed and low latency network. The switch network based on IP, the TDM switch network of high speed and low latency or other high speed switch network may be used to construct a baseband signal flow switch network.

As compared to the existing other structures, adopting a switch type baseband signal flow network makes the utilization of baseband processing resources more higher, makes the on-demand dynamic allocation of processing resources more easier and makes the optimization of system configuration more easier.

Remote Radio Frequency Interface Unit

The remote radio frequency interface unit 25 provides the interface between the main base station subsystem 21 and the remote radio frequency subsystem 22 through a proper remote signal transmission method. There are various analogue or digital multiplexing and transmission techniques which can be used to implement such interface. When there is a difference between the interface's signal format and the above baseband digital signal flow's format, there is needed a corresponding transformation in the remote radio frequency interface unit 25. When the radio frequency unit is locally in the base station system, the radio frequency unit may occupy the location of the remote radio frequency interface unit 25 of the present example in the system, and correspondingly the transport network 19 may be omitted, thereby obtaining the embodiment as shown in FIG. 3b.

Main Control Unit

The main control unit 29 is in charge of system management, monitoring and maintenance of the entire base station (including the remote radio frequency subsystem). At the same time, the unit is further in charge of management functions such as allocation, combination, scheduling and etc. of various processing resources within the base station. According to different system capacities, the functions such as system management, monitoring, maintenance, resource management and etc. may physically be performed on the same module within the main control unit 29; they may also be performed by different hardware modules. The interconnect channel between the unit and other units may be the above LAN local area network, and it may also be the channel such as PCI bus and etc. relevant to the hardware platform. In addition, the main control unit 29 may physically be a single processor, multiple processors or distributed processing system.

Clock Synchronization Unit

The clock synchronization unit 23 generates various timing signals such as sampling clock signal, chip clock, wireless frame synchronization signal, transmission line clock and etc. required by respective modules (remote radio frequency interface unit 25, baseband signal flow switch network 27, baseband processing unit 24, LAN switch network 28, base station controller interface unit 26, signaling unit 18) in the system by tracking GPS, BITS or synchronization reference signal from the base station controller through the base station controller interface unit, and transmits the clock signal to the modules through a special distribution network. In similar to other units, the clock synchronization unit 23 has an interface connected to the LAN switch network 28.

Signal Transmission Network

Various transmission techniques (adopting transmission medium such as optical fiber, cable and etc., based on analogue or digital transmission) and topology structures (star, ring, chain, tree and etc.) can be used to construct the signal transmission network 19 between the main base station subsystem 21 and the remote radio frequency subsystems. In addition, a cross interconnection device (analogue or digital) that can be controlled by the main control unit 29 (as shown by dashed line) is also employed in the establishment of the network, thereby further implementing a flexible mapping (not fixed mapping) between the transmission ports of remote radio frequency interface units 25 within the main base station subsystem 21 and the remote radio frequency subsystems 22. This feature can be used to support various backup manners of remote radio frequency interface units 25 in the main base station subsystem 21, thereby further increasing usability of the system.

FIG. 3b is a block diagram showing the structure of the centralized base station system 30 based on remote radio frequency units having local radio frequency units. In the structure as shown in FIG. 3b, the radio frequency unit 32 merges the remote radio frequency subsystem and the remote radio frequency interface unit in FIG. 3a and is locally located in the base station system. Since the remote transmission is not needed, the transport network 19 in FIG. 3a is omitted. The position of the radio frequency unit 32 in the base station system 30 is similar to the position of the remote radio frequency interface unit 25 in the base station system 20. Accordingly, the baseband signal flow switch network 37, baseband processing units 34, clock synchronization unit 33, LAN switch network 38, base station controller interface unit 36, main control unit 39 and signaling unit 31 in the base station system 30 are respectively similar to the baseband signal flow switch network 27, baseband processing units 24, clock synchronization unit 23, LAN switch network 28, base station controller interface unit 26, main control unit 29 and signaling unit 18 of FIG. 3a. Their connection relation, manner and operation are also similar to the example of FIG. 3a, and therefore their description is not repeated herein.

The above FIG. 3a is a case based on remote radio frequency units, and FIG. 3b is a case where the radio frequency units and the baseband processing are in the same location. The actual base station system may be a combination of both.

System Configuration

Since the baseband processing units, the radio frequency units and the remote radio frequency interface units are connected to the switch network through the same interface, the physical boards or cards of these units may employ general purpose module slots. Its benefit is that if the technique for implementing a module is changed, when the change of processing capacity of respective modules causes the change in the configuration proportion, the system is able to be easily adjusted to keep the optimal configuration.

Supposing there are N (N is an integer greater than 0) general purpose slots in total and there is an implementing technique such that the proportion between the baseband processing units and the remote radio frequency interface units is A/B, at time of optimal full configuration, the number of slots required by the baseband processing modules is M=N (A/(A+B)), and the rest are the slots of remote radio frequency interface units. When the technique development causes a change of A/B, the slot allocation may be easily adjusted so that M can follow the change, thereby always keeping the optimal configuration.

As stated above, the same interconnect manner through the switch network is also employed between shelves, so that the scheme is very suitable to support a multiple shelf structure.

In the above example, the radio frequency units are separated from the baseband processing resources, a high speed and low latency baseband signal switch network is employed between the baseband processing resource pool and the radio frequency modules or remote radio frequency modules to implement the interconnection, and the baseband processing resource pool and the base station controller interface module is interconnected with a LAN technique such as IP, fast Ethernet, giga Ethernet and etc., thereby supporting dynamic allocation of baseband processing resources, and supporting the base station system base station system architecture of multiple shelf extension and flexible system capacity system capacity extension. In the architecture, the respective functional modules are connected to the switch network, and a high speed differential signal serial transmission technique is employed between the functional modules and the switch network, so that the architecture may be easily implemented on various hardware platforms (such as CPCI, ATCA and etc.).

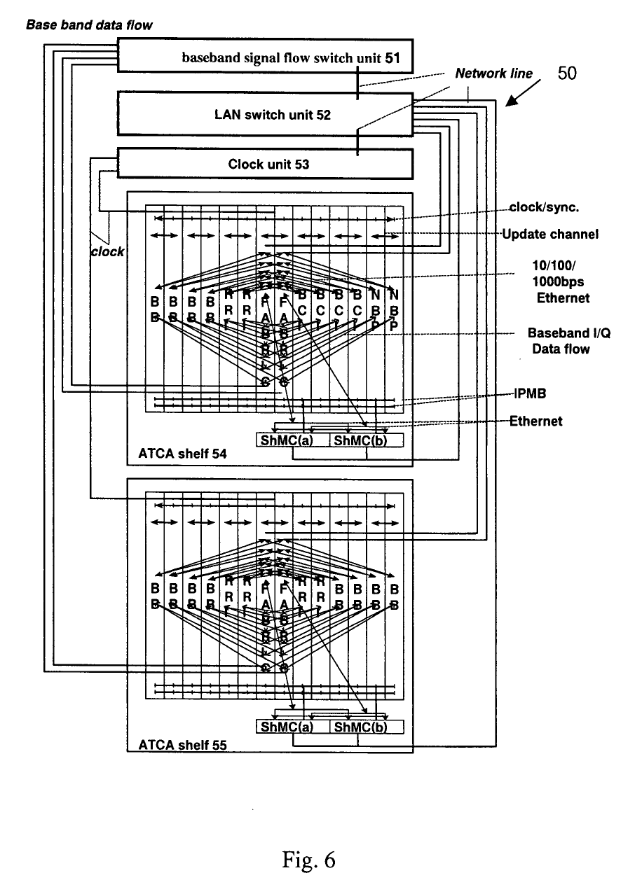

The embodiments of the present invention will be illustrated by referring to FIGS. 6-19 in the following.

FIG. 6 shows the main base station subsystem 50 of the centralized base station system based on the above extensible architecture and ATCA hardware platform.

The overall system 50 is formed by basic shelves 54, 55 based on ATCA platform plus baseband signal flow switch units 51, a LAN switch unit 52 and a clock unit 53. FIG. 6 shows an example having two shelves. The number of shelves actually supported depends on the capacity of the baseband signal flow switch unit and the LAN switch unit. The baseband signal flow switch unit, the LAN switch unit and the clock unit may be respective independent devices, and may also be formed by modules inserted into the ATCA shelf. Actually, when the number of shelves is lower, the baseband signal flow switch unit and the LAN switch unit may be eliminated, and a manner of directly connecting the shelves may be employed.

In FIG. 6, vertical rectangles denote the modules inserted into the shelves, and symbols labeled in the rectangles denote the types of the modules, wherein BCI denotes a base station controller interface module; FABRIC denotes a shelf main control module, also a switch module within the shelf for implementing LAN switch function, baseband data flow (may be an I/Q flow) switch function and clock signal distribution function at the same time, and the FABRIC in one of shelves in the overall system is the system's main control module (MFABRIC); BB denotes a baseband processing module; RRI denotes a remote radio frequency unit interface module; NBP denotes a signaling processing module; ShMC denotes a shelf management module. ShMC may be a separate module, and may also be integrated in the FABRIC module. FIGS. 6-10 further schematically describe the connection relation between the module through two-way straight arrows.

FABRIC represents a main control unit in the extensible architecture. BCI represents a base station controller interface unit in the extensible architecture. FABRIC and the LAN switch unit 52 represents a LAN switch network in the extensible architecture. BB represents a baseband processing unit in the extensible architecture. FABRIC and the baseband signal flow switch unit 51 represents a baseband signal flow switch network in the extensible architecture. RRI represents a remote radio frequency unit interface unit in the extensible architecture. NBP represents a signaling unit in the extensible architecture. FABRIC and the clock unit 53 represents a clock synchronization unit in the extensible architecture.

Although only RRI is shown here, one skilled in the art knows that radio frequency units of the extensible architecture may also be integrated into the system 50.

The following is the detailed description about the network scheme and signal path in the system 50.

Forming Scheme of the LAN Switch Network

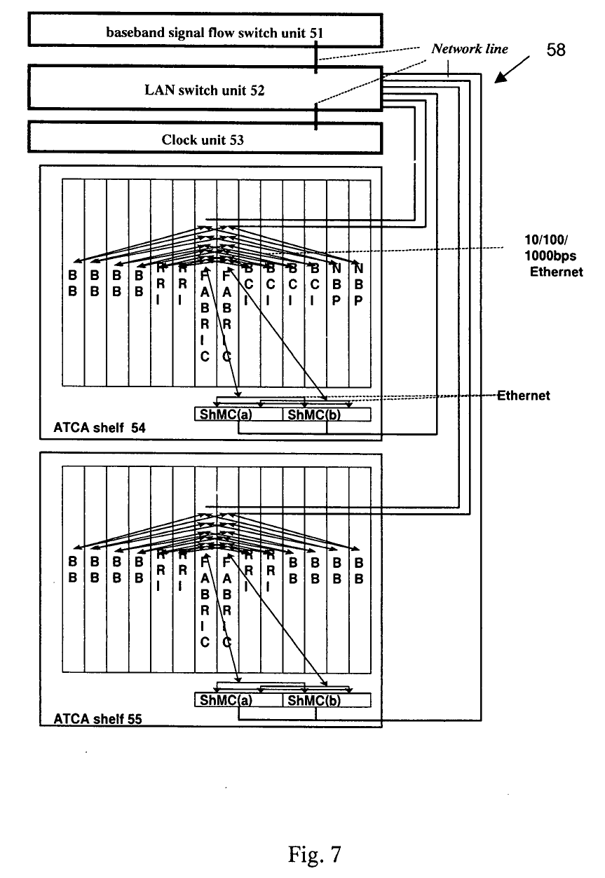

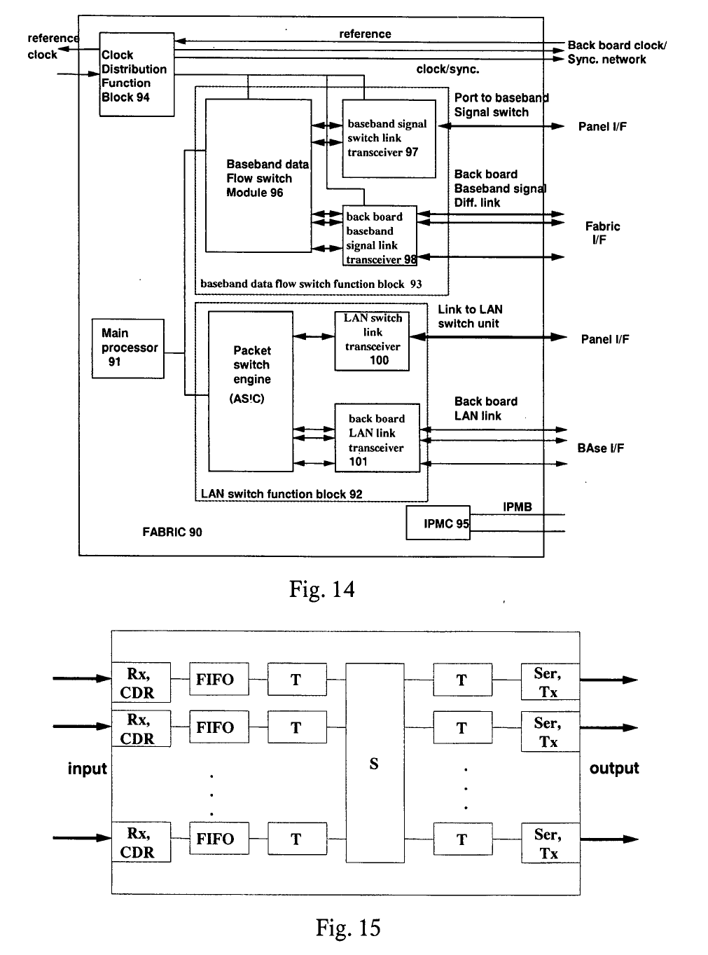

FIG. 7 is a schematic diagram illustrating the coverage of the LAN switch network 58. As shown in FIG. 7, the LAN switch network 58 is implemented by a LAN switch function block 92 (see FIG. 14) in the FABRIC module within ATCA shelves 54-55 and a LAN switch unit 52 for LAN interconnection between shelves. The LAN switch function block 92 is interconnected with the LAN switch unit 52 through cable or optical fiber, and the LAN switch function block 92 covers the respective modules within the shelves through dual star back board Ethernet links defined by BASE interfaces on the ATCA back boards. This structure puts all the modules within the coverage of the LAN switch network, and there is also an Ethernet link between the FABRIC and the ShMC. In the system, the transmission of user data flow between the base station controller interface module (BCI) and the baseband processing module (BB) is carried out by the LAN switch network 58.

Forming Scheme of the Baseband Signal Flow Switch Network

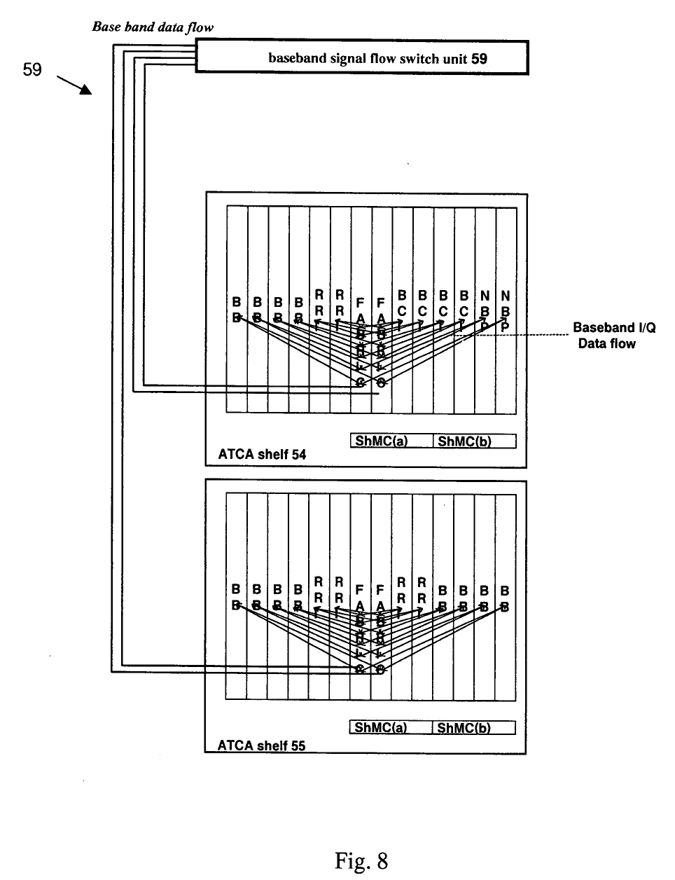

FIG. 8 is a schematic diagram illustrating the coverage of the baseband signal flow (for example I/Q signal flow) switch network 59. As shown in FIG. 8, the baseband signal flow switch network 59 is implemented by a baseband data flow switch function block 93 (see FIG. 14) in the FABRIC module within ATCA shelves 54-55 and a baseband signal flow switch unit 51 for baseband (I/Q) signal flow interconnection between shelves. The baseband data flow switch function block 93 is interconnected with the baseband signal flow switch unit 51 through high speed differential signal cable (such as LVDS) or optical fiber. The baseband data flow switch function block 93 covers the modules within the shelves through dual star high speed serial differential signal links define by the FABRIC interfaces on the ATCA back boards. This structure puts all the RRI and BB modules within the coverage of the baseband data flow switch network. In the system, the transmission of baseband data flow between the remote radio frequency unit interface module (RRI) and the baseband processing module (BB) is carried out by the baseband data flow switch network. The connections as shown by two-way arrows between the FABRICs and the BCIs only denote that the baseband signal flow switch network also covers the slots occupied by the BCIs in the figure, so that these slots become general purpose slots that can be used for RRI, BB and BCI.

Forming of the Clock Synchronization Network

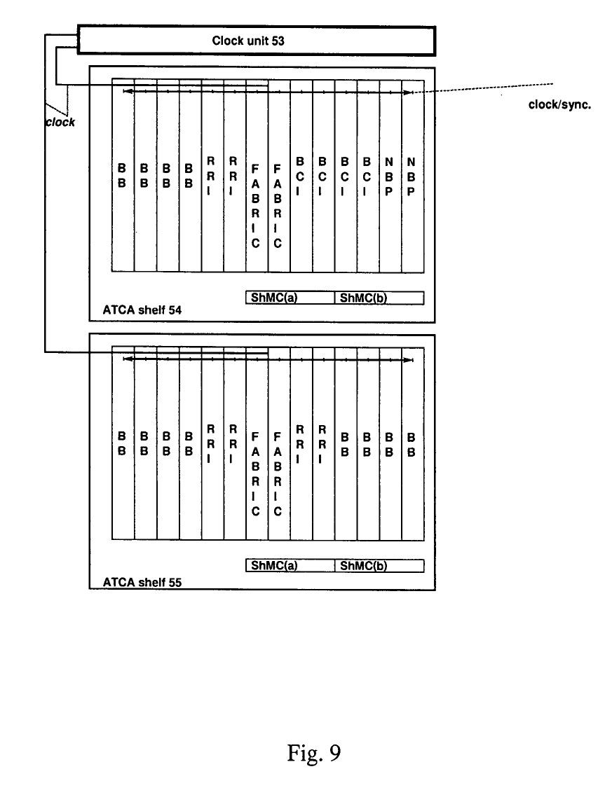

FIG. 9 is a schematic diagram illustrating the coverage of a clock synchronization network. As shown in FIG. 9, the clock synchronization network is formed by a clock unit 53 and clock allocation function blocks 94 (see FIG. 14) in the FABRIC modules within ATCA shelves. The clock unit 53 generates various timing signals as required by tracking GPS, BITS or the synchronization reference signal sent from the base station controller. These timing signals are transmitted to the clock allocation function blocks in the FABRIC modules within the respective ATCA shelves and after being driven, are transmitted to the respective modules through the clock links on the back boards. In one alternative embodiment, the clock allocation function block may also select the synchronization reference signal extracted by the BCI module to transmit to the clock unit.

User Data Flow Channel

In the downlink direction, after the BCI receives the user data flow from the base station controller and performs relevant processing of the interface protocol, according to the control of resource management, the user data flow is transmitted to the specified BB module for processing through the LAN switch network. The baseband digital signal flow generated by the BB is transmitted to the specified RRI interface module through the baseband signal flow switch network, and is further transmitted to a corresponding radio frequency unit for transmitting.

In the uplink direction, the RRI receives the signal from the radio frequency unit, converts it into an internal baseband signal flow format, and transmits it to the BB module (one or more modules) determined by the resource management for processing through the baseband signal flow switch network. The user data flow obtained by the processing is transmitted to the BCI through the LAN switch network for forwarding to the base station controller.

Signaling Channel

The BCI performs function of the signaling channel transport layer (such as AAL, ATM of Iub and etc.), and then the separated signaling flow is forwarded to the NBP module for signaling protocol processing (such as NBAP, ALCAP of Iub and etc.) through the LAN switch network. The NBP interacts with the system main control unit (MFABRIC) through the LAN switch network.

Management Path

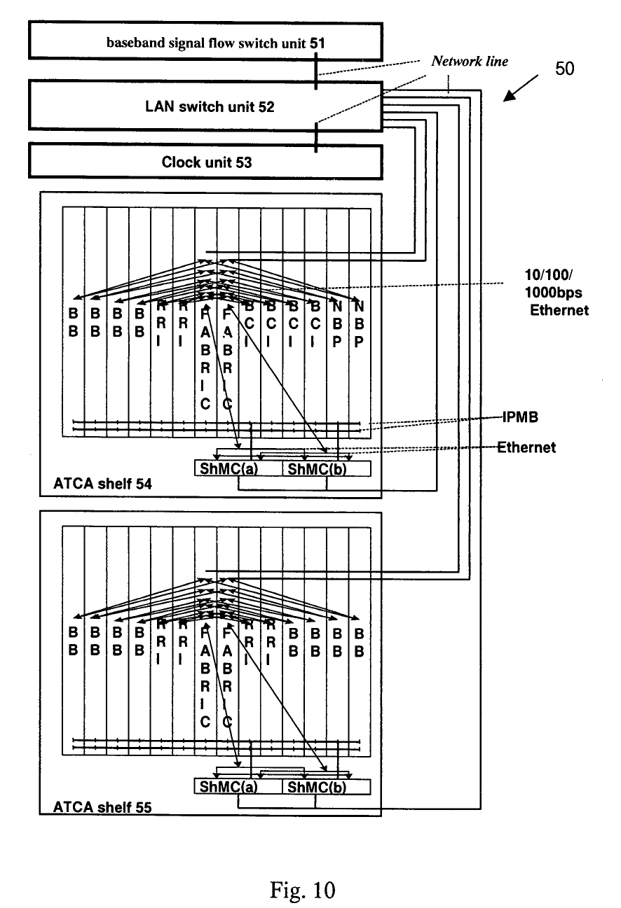

FIG. 10 is a schematic diagram illustrating the management channel. The LAN switch network and the IPMB bus are primary management paths. The main system management function resides on the system main control FABRIC module, and the system main control FABRIC module may be generated by electing among all the FABRIC modules or generated in other manners. The main control FABRIC module is denoted with MFABRIC. The underlying basic management of a shelf resides in the ShMC, and the management of the higher layer and application layer is performed by the FABRIC.

In the power on policy, the ShMC controls the FABRIC to be powered on preferentially, and afterwards, it is possible to implement the management to other modules under the control of the FABRI (there is an Ethernet link between the FABRIC and the ShMC).

The ShMC and the FABRIC both have a port directly interfacing with the local management terminal.

Shelf underlying management channel: (symbols within parentheses denote the network passing through)

Management terminal->ShMC->(IPMB)->IPMCs on respective modules, or

Management terminal->FABRIC->(LAN)->ShMC->(IPMB)->IPMCs on respective modules

Higher layer management channel (for BootTP, SNMP and etc.):

For management of modules within the ATCA shelves:

Management terminal->(LAN)->MFABRIC->(LAN)->Respective modules

For management of the clock unit:

Management terminal->(LAN)->MFABRIC->(LAN)->Clock unit;

For management of the LAN switch unit:

Management terminal->(LAN)->MFABRIC->(LAN)->LAN switch unit;

For management of the baseband signal flow switch unit:

Management terminal->(LAN)->MFABRIC->(LAN)->Baseband signal flow switch unit

When the NMS is at the base station controller side, the management channel is:

NMS->(Base station controller-base station interface)->BCI->(LAN)->MFABRIC . . . .

The path after the management channel reaches the MFABRIC is the same as the case of the local management terminal, and is not repeated here.

If the base station controller-base station interface carries a dedicated underlying management link, and the link is separated before entering into the BCI and is transmitted to the ShMC, it is able to fully control the system's underlying management remotely, without predefining too many polices on the ShMC. (such as the policy of preferentially power on of the FABRIC).

Application of the Update Channel

As shown in FIG. 6, there is reserved an Update channel between adjacent slots. If needed, the Update channel is employed as a high speed direct channel between modules (such as between SDH interface cards).

Redundant System Backup

The adjacent FABRICs employ a primary/secondary redundant scheme or a load-sharing manner, and preferably employ the primary/secondary scheme.

The ShMC within a shelf employs the primary/secondary redundant scheme.

The BCI interface module may employ an 1+1 primary/secondary scheme, i.e., each pair of BCIs have a primary/secondary relation.

Since the BB is connected to the switch network in both uplink and downlink directions, it is possible to employ various backup schemes such as N+1, N+M, N: M and etc.

The RRI may employ 1+1 backup or cool backup scheme, and when the transmission network to the remote radio frequency unit employs a suitable cross interconnection device, it may support various schemes such as N+1, N+M, N: M and etc.

The clock module implements high usability through the replaceable redundant configuration of the clock integrated function block.

The LAN switch unit and the baseband signal flow switch unit may implement the redundancy by multiple devices via the interconnection of a proper topology structure, and may also achieve high usability by the redundant configuration of modules within a device.

Since adopting the switch network interconnection, the respective shelves may also be the backup for each other, and especially when the shelf where the MFABRIC is located fails, the FABRIC module as a backup in other shelf may take over its work through a certain mechanism.

The arrangement of the above respective modules will be described in detail by referring to the figures.

Arrangement of the BCI Module

The BCI module is used for performing functions (1)-(6) of the base station controller interface unit 26 in the above embodiment of the present invention.

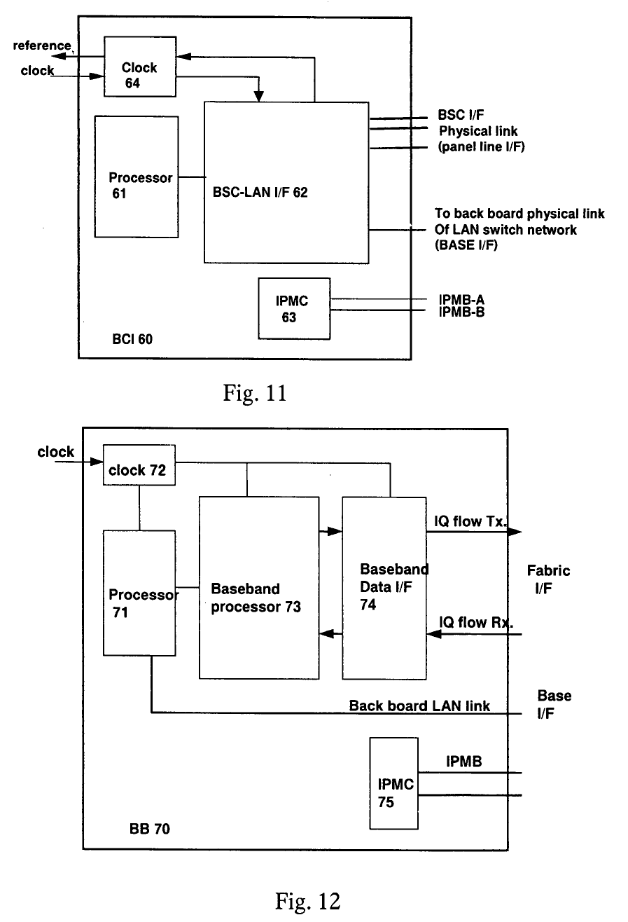

FIG. 11 shows one embodiment of the BCI module. As shown in FIG. 11, the BCI module 60 comprises a processor 61, a base station controller-LAN interface 62, an IPMC 63 and a clock circuit 64. Said functions (1)-(6) are mainly performed by the base station controller-LAN interface 62. As a nonrestrictive preferable embodiment, the base station controller-LAN interface 62 may be implemented by a network processor. The “processor” as shown is a general purpose processor which acts as a module manager and has a link to the LAN switch network. The intelligent platform management controller function block (IPMC) in FIG. 11 is in charge of communicating with the shelf management controller (ShMC) through the intelligent platform management bus (IPMB) to perform the underlying management to the BCI module. The clock circuit 64 is in charge of obtaining required timing signal from the clock allocation network and distributing the timing signal within the board, and may extract a reference clock and provide it to the clock synchronization unit.

Arrangement of the BB Module

The BB module is used for the function as described in the above with respect to the baseband processing unit 24.

FIG. 12 shows one embodiment of the BB module. As shown in FIG. 12, the BB module 70 comprises a processor 71, a clock circuit 72, a baseband processor 73, a baseband data interface 74 and an IPMC 75. Each BB module 70 may process one to multiple baseband I/Q signal flows. The BB module 70 has a LAN on the back board BASE interface, which is used as a management channel and the channel for user data flow transmission with the base station controller interface module BCI. The baseband processing function block 73 in the module 70 is a core, and is implemented by a suitable number of DSPs or baseband processing ASIC. The baseband data interface 74 performs differential link driving/receiving and signal format transformation function to the baseband signal flow of the back board FABRIC interface, and may be formed by a proper FPGA or driver. The general purpose processor 71 is the manager of the entire board. The clock circuit 72 is in charge of obtaining the required timing signal from the clock allocation network and distributing the timing signal within the board. The IPMC 75 is in charge of communicating with the ShMC through the IPMB to perform underlying management to the BB module.

The work flow of the module is: in the downlink direction, the processor 71 receives a user data flow from the LAN link of the back board BASE interface, and transmits it, after a proper format transformation, to the baseband processor 73 for baseband processing. The data flow formed by the baseband processing, after a proper signal format transformation by the baseband data interface 74 (including multiplexing), becomes the signal format supported by the baseband signal flow switch network and is transmitted through the back board FABRIC interface signal link. In the uplink direction, the baseband signal from the back board FABRIC interface link is converted into the form acceptable by the baseband processor 73 and is transmitted to the baseband processor 73 for processing, and the obtained user data flow is transmitted to the processor 71 to be converted into the packet format of the BASE interface LAN switch network for forwarding.

The baseband processing may also adopt a scheme where the chip level processing (spreading/despreading, scrambling/descramble and etc.) and the symbol level processing (channel coding and decoding, multiplexing/demultiplexing, rate adaptation and etc.) are implemented by separate hardware modules. In such a scheme, the data flows from multiple chip level processing modules and corresponding to the same channel (reception diversity) may be combined in the symbol level processing module and then the combined data flow undergoes a symbol level decision decoding. When adopting the separating scheme, the data flow transmission between the chip level processing module and the symbol level processing module is performed through the LAN network. At this time, the chip level processing module interfaces with the radio frequency portion through the baseband signal flow switch network, and the symbol level processing module communicates with the base station controller interface module through the LAN network.

Arrangement of the RRI Module

The RRI module performs the function of said remote radio frequency interface unit in the architecture, and implements the interface between the main base station subsystem and the remote radio frequency subsystem through a proper remote signal transmission method, the main function of which is to perform adaptation between the internal baseband signal and the remote transmission interface, and etc.

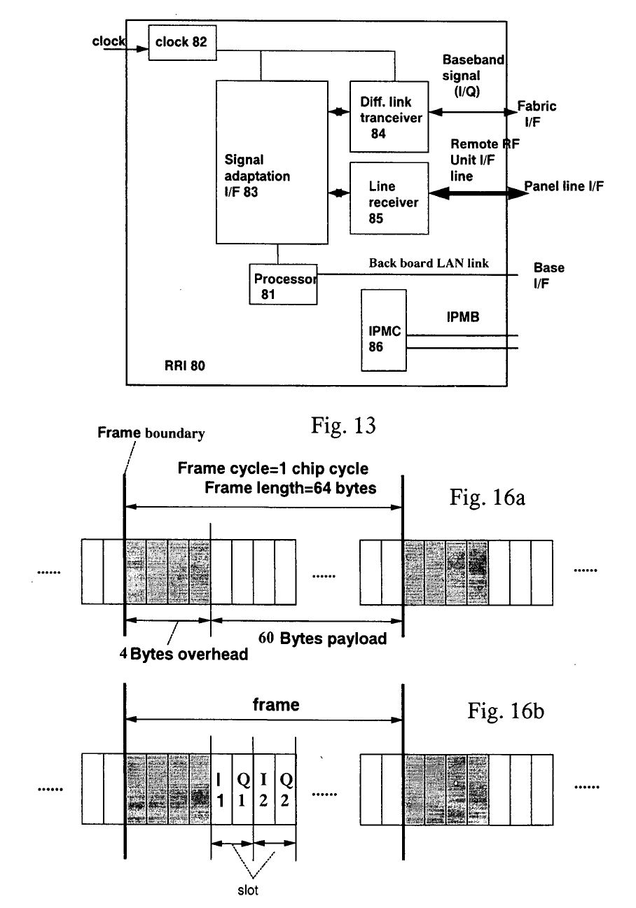

FIG. 13 shows one embodiment of the RRI module. As shown in FIG. 13, the RRI module 80 comprises a clock circuit 82, a processor 81, a signal adaptation interface 83, a differential link transceiver 84, a line transceiver 85 and an IPMC 86. The LAN interface of the module on the BASE interface is for purpose of management and control. The signal adaptation interface 83 performs functions such as signal synthesis, multiplexing/demultiplexing, format adaptation and etc., to implement the format adaptation between the baseband signal flow format within the main base station subsystem and the remote radio frequency unit interface signal, and multiplexing/demultiplexing. It may further perform signal synthesis (such as adding several I/Q signal flows). The signal adaptation interface 83 may be implemented by FPGA, ASIC or a proper combination thereof. The differential link transceiver 84 performs differential link driving/receiving function to the back board baseband signal flow, and may be implemented by FPGA or a proper driver/receiver. The line transceiver 85 remote radio frequency unit interface line function, and may be implemented by a proper ASIC according to the utilized transmission technique. The processor 81 may be implemented by a general purpose processor, and is the manager of the entire board. The IPMC is in charge of communicating with the ShMC through the IPMB to perform underlying management to the RRI module. When the radio frequency module is at a near end, it may substitute the RRI module's position.

Arrangement of the FABRIC Module

FIG. 14 is a block diagram showing the structure of the FABRIC module 90. The FABRIC module 90 comprises a main processor 91, a clock allocation function block 94, a LAN switch function block 92, a baseband (I/Q) data flow switch function block 93 and an IPMC 95.

The LAN switch function block 92 comprises a packet switch engine 99, a LAN switch link transceiver 100 for providing a port connected to the LAN switch unit outside the shelf, and a back board LAN link transceiver 101 for providing the LAN switch function within the shelf. Its main functional unit is the packet switch engine 99 for performing a packet forwarding function. When adopting the LAN technique of IP/Ethernet, the functional unit may adopt an IP/Ethernet layer 2/layer 3 switch chip. The upper layer management protocols relevant to the LAN switch network, such as simple network management protocol (SNMP), Ethernet generating tree protocol (Spanning-Tree) and etc. are carried out on the main processor.

The baseband data flow switch function block 93 comprises a baseband data flow switch module 93, a baseband signal switch link transceiver 97 for providing a port connected to the baseband signal flow switch unit outside the shelf through a front panel or the panel of a rear plug board, and a back board baseband signal link transceiver 98 for providing the baseband signal flow switch function within the shelf through the back board FABRIC interface. The line transmitting and receiving function of the baseband signal switch link transceiver 97 and the back board baseband signal link transceiver 98 is performed by a proper transceiver or a transceiver embedded in the FPGA or ASIC. The core functional unit of the function block is the baseband data flow switch module 96.

As an example of a nonrestrictive arrangement, the baseband data flow switch module 96 may adopt high speed time division multiplexing (TDM) switch arrangement and is implemented by FPGA. A block diagram of the FPGA example of the WCDMA FDD baseband data flow switch implemented by adopting the high speed time division multiplexing switch arrangement is shown in FIG. 15, a schematic diagram of the TDM frame structure utilized on its transmitting and receiving lines is shown in the figure, and the mapping from the baseband data flow to the TDM frame payload is shown in FIG. 16b. In the example, each TDM frame cycle is one chip cycle (1/3.84 μs) after the spreading of a WCDMA FDD baseband processing, and each frame has 64 bytes, wherein 4 bytes are the header overhead, which may be used for purpose of frame demarcation, and the remaining 60-byte payload is used for carrying the I/Q code flow, where the line encoding may adopt the 8B/10B encoding arrangement. Actually, there are various arrangements for the mapping from the baseband data flow to the TDM frame structure, and that as shown in FIG. 16b is only an example.

The clock allocation function block 94 is used for distributing the clock signal to the respective modules within the shelf. The function block obtains the clock/synchronization signal from the clock unit, and transmits it to the respective modules in the shelf through the back board clock synchronization bus after buffering/driving. The reference clock signal from the base station controller line is transmitted to the clock unit after the selection.

The main processor 91 of the FABRIC module is formed by a CPU with higher processing capacity, and is a FABRIC module manager. It is also a higher layer management agent of the shelf or system, and is also a system main control unit. When it is necessary to extend the processing capacity, it is possible to add a hardware module the same as the NBP as a co-processor.

The IPMC 95 is in charge of communicating with the ShMC through the IPMB to perform underlying management to the FABRIC module.

Since the ATCA has larger single board area, it may accommodate the above respective function blocks. If required, the respective function blocks or the function block combination may also be respectively implemented by adopting separated physical modules.

Arrangement of the NBP Module

The NBP module is used for performing a function of signaling unit in the system architecture, and is in charge of protocol processing required by the signaling transmission between the base station and the base station controller. By taking UMTS as an example, the module performs processing of NBAP, ALCAP protocols. The signaling flow to be processed by the unit is obtained by the flow separating function of the base station controller interface unit (BCI). The module interacts with the system main control unit through the LAN on the BASE interface.

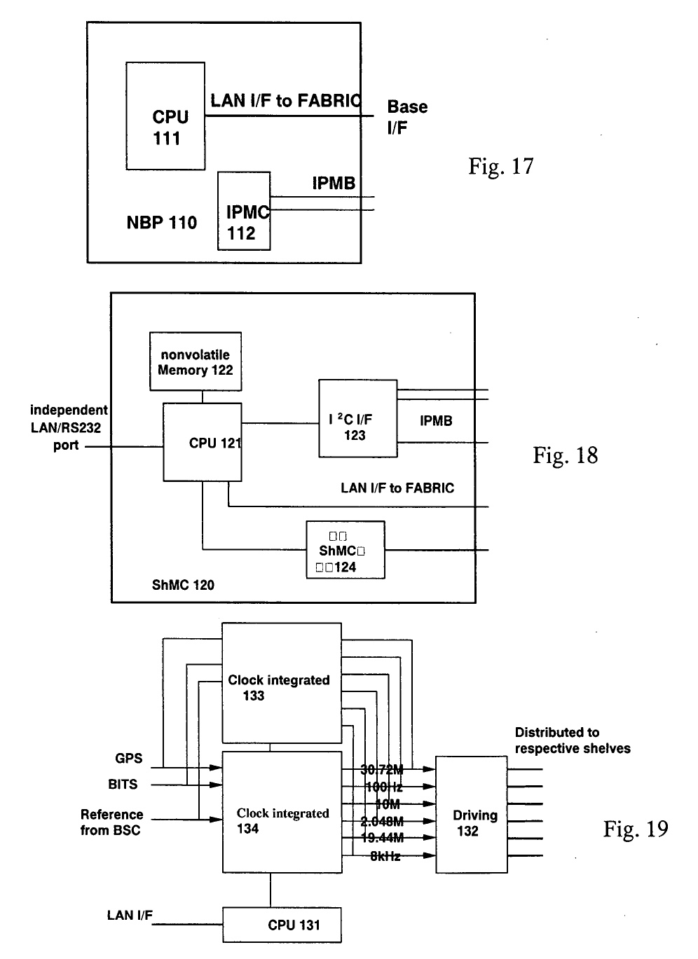

The arrangement of the NBP module is as shown in FIG. 17. The module 110 has an IPMC 112 and a CPU 111. The CPU 111 is formed by a general purpose processor having a certain processing capacity, and provides processing capacity to the system. The IPMC 112 is in charge of communicating with the ShMC through the IPMB to perform underlying management to the NBP module. When the main control module of the system needs to extend the processing capacity such as resource management ability, a physical module of the type may be used as a co-processor.

Arrangement of the ShMC Module

FIG. 18 shows an example of the ShMC module. As shown in FIG. 18, the ShMC module 120 comprise a microprocessor 121, a nonvolatile memory 122, an I²C interface circuit 123 and an adjacent ShMC board interface 124. The ShMC module 120 is a underlying manager of the shelf, and is in charge of management functions such as shelf sensor management, fan management, module power supply management and etc. The module is connected to respective modules of the IPMC function block through a star type or bus type I²C link. The module has an independent port (LAN, RS232) for connecting the management network or local management terminal, and also has a LAN link to the FABRIC module.

Arrangement of the LAN Switch Unit

The LAN switch may be implemented by adopting a layer 2/layer 3 switch of the IP/Ethernet technique.

Arrangement of the Baseband Signal Flow Switch Unit

Baseband signal flow switch unit may employ a different arrangement according to different switch mechanisms. When adopting the IP/Ethernet technique, it can be implemented by a layer 2/layer 3 switch; when adopting the TDM technique, it may adopt a chip or module having the switch function as shown in FIG. 15, wherein the switch mechanism is constructed according to the extension technique of the TDM switch network.

Arrangement of the Clock Unit

The clock unit is the core of the system clock network, and its arrangement is as shown in FIG. 19 where the various frequencies as shown are only examples. Clock integrated modules 133, 134 which are primary/secondary for each other synthesize various required clock/synchronization signal according to a reference signal and distribute them to the respective shelves through a driving circuit 132. The CPU 131 performs a management control function and a protocol function relevant to the clock synchronization, and has a LAN interface for communicating with other modules.

1. A centralized base station system based on advanced telecommunication computer architecture ATCA including a main base station subsystem and one or more remote radio frequency subsystems, said remote radio frequency subsystem being in charge of signal reception and transmission of respective cells, said main base station subsystem comprising:
one or more shelves based on ATCA platform, each shelf comprising at least one control switch module of ATCA board form;
one or more base station controller interface modules in form of ATCA boards inserted into the shelves, for providing transmission interfaces with the base station controller for the base station system;
a signaling module in form of a ATCA board inserted into the shelf, for performing protocol processing required by the signaling transmission between the base station system and the base station controller, so as to provide processing support for said base station controller interface unit;
one or more baseband processing modules in form of ATCA boards inserted into the shelves, for performing baseband processing of wireless protocol physical layer procedure to uplink wireless signals from the cells and a downlink user data flow from the base station controller;
one or more remote radio frequency interface modules in form of ATCA boards inserted into the shelves, for providing interfaces with the remote radio frequency subsystems for the main base station subsystem;
a first switch network comprising shelf back board BASE interface links, said control switch modules and a first network switch unit, wherein the modules of said base station controller interface module, signaling module, baseband processing module and remote radio frequency interface module in the same shelf are connected to the control switch module through the shelf back board BASE interface links, the control switch module provides data exchange within the shelf, the control switch modules within the respective shelves are connected to the first network switch unit, and the first network switch unit provides data exchange between the shelves;
a second switch network comprising shelf back board FABRIC interface links, said control switch modules and a second network switch unit, wherein the modules of said baseband processing module and remote radio frequency interface module in the same shelf are connected to the control switch module through the shelf back board FABRIC interface links, the control switch module provides baseband signal flow exchange within the shelf, the control switch modules within the respective shelves are connected to the second network switch unit, and the second network switch unit provides baseband signal flow exchange between the shelves;
a clock synchronization network comprising a shelf back board clock synchronization bus, said control switch module and a clock unit, wherein the clock unit is used for obtaining a reference clock and providing a clock synchronization signal to the control switch modules of the respective shelves, the control switch module provides the clock synchronization signal to the respective modules in the same shelf through the shelf back board clock synchronization bus; and
a signal transmission network for transmitting baseband signal flows between the remote radio frequency interface modules and the remote radio frequency subsystems,
wherein said second network switch unit and clock unit are further connected to the first network switch unit so as to be connected to the first switch network, and said control switch module is in charge of controlling respective portions in the same shelf, and wherein one of the control switch modules of all the shelves is a main control module in charge of controlling the control switch modules within other shelves and other components outside the shelves within the system through the first switch network.

2-10. (canceled)

11. The centralized base station system of claim 1, wherein when the shelf where the main control module is located fails, its work is taken over by the control module of another shelf according to a predetermined mechanism.

12. The centralized base station system of claim 1, wherein more than one baseband processing units process one baseband signal flow or user data flow in a load-sharing manner.

13. (canceled)

14. The centralized base station system of claim 1, wherein the base station controller interface module performs the transport layer function of the interface between the base station system and the base station controller.

15. (canceled)

16. The centralized base station system of claim 1, wherein in the downlink direction, the base station controller interface module separates a signaling flow and user data flows from the downlink data flow, and transmits them to the signaling module and respective baseband processing modules through the first switch network; in the uplink direction, the base station controller interface module multiplexes a signaling flow and user data flows from the respective baseband processing modules into the uplink data flow.

17. The centralized base station system of claim 1, wherein the base station controller interface module performs protocol format transformation of data flows between the transmission with the base station controller and the exchange with internal modules of the base station system.

18. (canceled)

19. The centralized base station system of claim 1, wherein the base station controller interface module performs collection/distribution of the user data flows.

20. The centralized base station system of claim 1, wherein the base station controller interface module performs synchronization extracting.

21. The centralized base station system of claim 1, wherein in the uplink direction, according to a task allocation policy, the main control module specifies so that a baseband sampling signal flow of any one cell is switched to any one baseband processing module for processing, or is copied to a plurality of baseband processing modules for processing; in the downlink direction, according to the task allocation policy, the main control module specifies so that a user data flow of any one cell is switched to any one baseband processing module for processing, or is copied to a plurality of baseband processing modules for processing.

22. The centralized base station system of claim 21, wherein each baseband processing unit is able to process one to multiple baseband data flows at the same time.

23. (canceled)

24. A centralized base station system based on advanced telecommunication computer architecture ATCA including a main base station subsystem and one or more remote radio frequency subsystems, said remote radio frequency subsystem being in charge of signal reception and transmission of respective cells, said main base station subsystem comprising:
one or more shelves based on ATCA platform, each shelf comprising at least one control module of ATCA board form;
one or more base station controller interface modules in form of ATCA boards inserted into the shelves, for providing transmission interfaces with the base station controller for the base station system;
a signaling module in form of a ATCA board inserted into the shelf, for performing protocol processing required by the signaling transmission between the base station system and the base station controller, so as to provide processing support for said base station controller interface unit;
one or more baseband processing modules in form of ATCA boards inserted into the shelves, for performing baseband processing of wireless protocol physical layer procedure to uplink wireless signals from the cells and a downlink user data flow from the base station controller;
one or more remote radio frequency interface modules in form of ATCA boards inserted into the shelves, for providing interfaces with the remote radio frequency subsystems for the main base station subsystem;
a first switch network comprising shelf back board BASE interface links, first network switch modules and a first network switch unit, wherein the modules of said control module, base station controller interface module, signaling module, baseband processing module and remote radio frequency interface module in the same shelf are connected to the first network switch module through the shelf back board BASE interface links, the first network switch module provides data exchange within the shelf, the first network switch modules within the respective shelves are connected to the first network switch unit, and the first network switch unit provides data exchange between the shelves;
a second switch network comprising shelf back board FABRIC interface links, second network switch modules and a second network switch unit, wherein the modules of said baseband processing module and remote radio frequency interface module in the same shelf are connected to the second network switch module through the shelf back board FABRIC interface links, the second network switch module provides baseband signal flow exchange within the shelf, the second network switch modules within the respective shelves are connected to the second network switch unit, and the second network switch unit provides baseband signal flow exchange between the shelves;
a clock synchronization network comprising a shelf back board clock synchronization bus, clock allocation modules and a clock unit, wherein the clock unit is used for obtaining a reference clock and providing a clock synchronization signal to the clock allocation modules of the respective shelves, the clock allocation module provides the clock synchronization signal to the respective modules in the same shelf through the shelf back board clock synchronization bus; and
a signal transmission network for transmitting baseband signal flows between the remote radio frequency interface modules and the remote radio frequency subsystems,
wherein said second network switch unit and clock unit are further connected to the first network switch unit, in order to be connected to the first switch network,
said first network switch module, second network switch module and clock allocation module are in form of ATCA boards inserted into the shelves, and are connected to the first network switch module in the same shelf through the shelf back board BASE interface link, and
said control module is in charge of controlling respective portions in the same shelf, and one of the control switch modules of all the shelves is a main control module in charge of controlling the control modules within other shelves and other components outside the shelves within the system through the first switch network.

25-33. (canceled)

34. The centralized base station system of claim 24, wherein when the shelf where the main control module is located fails, its work is taken over by the control module of another shelf according to a predetermined mechanism.

35. The centralized base station system of claim 24, wherein more than one baseband processing units process one baseband signal flow or user data flow in a load-sharing manner.

36. (canceled)

37. The centralized base station system of claim 24, wherein the base station controller interface module performs the transport layer function of the interface between the base station system and the base station controller.

38. (canceled)

39. The centralized base station system of claim 24, wherein in the downlink direction, the base station controller interface module separates a signaling flow and user data flows from the downlink data flow, and transmits them to the signaling module and respective baseband processing modules through the first switch network; in the uplink direction, the base station controller interface module multiplexes a signaling flow and user data flows from the respective baseband processing modules into the uplink data flow.

40. The centralized base station system of claim 24, wherein the base station controller interface module performs protocol format transformation of data flows between the transmission with the base station controller and the exchange with internal modules of the base station system.

41. (canceled)

42. The centralized base station system of claim 24, wherein the base station controller interface module performs collection/distribution of the user data flows.

43. The centralized base station system of claim 24, wherein the base station controller interface module performs synchronization extracting.

44. The centralized base station system of claim 24, wherein in the uplink direction, according to a task allocation policy, the main control module specifies so that a baseband sampling signal flow of any one cell is switched to any one baseband processing module for processing, or is copied to a plurality of baseband processing modules for processing; in the downlink direction, according to the task allocation policy, the main control module specifies so that a user data flow of any one cell is switched to any one baseband processing module for processing, or is copied to a plurality of baseband processing modules for processing.

45. The centralized base station system of claim 44, wherein each baseband processing unit is able to process one to multiple baseband data flows at the same time.

46. (canceled)

47. A centralized base station system based on advanced telecommunication computer architecture ATCA, comprising:
one or more shelves based on ATCA platform, each shelf comprising at least one control switch module of ATCA board form;
one or more radio frequency modules in form of ATCA boards inserted into the shelves, being in charge of signal reception and transmission of respective cells;
one or more base station controller interface modules in form of ATCA boards inserted into the shelves, for providing transmission interfaces with the base station controller for the base station system;
a signaling module in form of a ATCA board inserted into the shelf, for performing protocol processing required by the signaling transmission between the base station system and the base station controller, so as to provide processing support for said base station controller interface unit;
one or more baseband processing modules in form of ATCA boards inserted into the shelves, for performing baseband processing of wireless protocol physical layer procedure to uplink wireless signals from the cells and a downlink user data flow from the base station controller;
a first switch network comprising shelf back board BASE interface links, said control switch modules and a first network switch unit, wherein the modules of said base station controller interface module, signaling module, baseband processing module and radio frequency module in the same shelf are connected to the control switch module through the shelf back board BASE interface links, the control switch module provides data exchange within the shelf, the control switch modules within the respective shelves are connected to the first network switch unit, and the first network switch unit provides data exchange between the shelves;
a second switch network comprising shelf back board FABRIC interface links, said control switch modules and a second network switch unit, wherein the modules of said baseband processing module and radio frequency module in the same shelf are connected to the control switch module through the shelf back board FABRIC interface links, the control switch module provides baseband signal flow exchange within the shelf, the control switch modules within the respective shelves are connected to the second network switch unit, and the second network switch unit provides baseband signal flow exchange between the shelves;
a clock synchronization network comprising a shelf back board clock synchronization bus, said control switch module and a clock unit, wherein the clock unit is used for obtaining a reference clock and providing a clock synchronization signal to the control switch modules of the respective shelves, the control switch module provides the clock synchronization signal to the respective modules in the same shelf through the shelf back board clock synchronization bus,
wherein said second network switch unit and clock unit are further connected to the first network switch unit so as to be connected to the first switch network, and said control switch module is in charge of controlling respective portions in the same shelf, and wherein one of the control switch modules of all the shelves is a main control module in charge of controlling the control switch modules within other shelves and other components outside the shelves within the system through the first switch network.

48. A centralized base station system based on advanced telecommunication computer architecture ATCA, comprising:
one or more shelves based on ATCA platform, each shelf comprising at least one control module of ATCA board form;
one or more radio frequency modules in form of ATCA boards inserted into the shelves, being in charge of signal reception and transmission of respective cells;
one or more base station controller interface modules in form of ATCA boards inserted into the shelves, for providing transmission interfaces with the base station controller for the base station system;
a signaling module in form of a ATCA board inserted into the shelf, for performing protocol processing required by the signaling transmission between the base station system and the base station controller, so as to provide processing support for said base station controller interface unit;
one or more baseband processing modules in form of ATCA boards inserted into the shelves, for performing baseband processing of wireless protocol physical layer procedure to uplink wireless signals from the cells and a downlink user data flow from the base station controller;
a first switch network comprising shelf back board BASE interface links, first network switch modules and a first network switch unit, wherein the modules of said control module, base station controller interface module, signaling module, baseband processing module and radio frequency module in the same shelf are connected to the first network switch module through the shelf back board BASE interface links, the first network switch module provides data exchange within the shelf, the first network switch modules within the respective shelves are connected to the first network switch unit, and the first network switch unit provides data exchange between the shelves;
a second switch network comprising shelf back board FABRIC interface links, second network switch modules and a second network switch unit, wherein the modules of said baseband processing module and radio frequency module in the same shelf are connected to the second network switch module through the shelf back board FABRIC interface links, the second network switch module provides baseband signal flow exchange within the shelf, the second network switch modules within the respective shelves are connected to the second network switch unit, and the second network switch unit provides baseband signal flow exchange between the shelves;
a clock synchronization network comprising a shelf back board clock synchronization bus, clock allocation modules and a clock unit, wherein the clock unit is used for obtaining a reference clock and providing a clock synchronization signal to the clock allocation modules of the respective shelves, the clock allocation module provides the clock synchronization signal to the respective modules in the same shelf through the shelf back board clock synchronization bus,
wherein said second network switch unit and clock unit are further connected to the first network switch unit, in order to be connected to the first switch network,
said first network switch module, second network switch module and clock allocation module are in form of ATCA boards inserted into the shelves, and are connected to the first network switch module in the same shelf through the shelf back board BASE interface link, and
said control module is in charge of controlling respective portions in the same shelf, and one of the control switch modules of all the shelves is a main control module in charge of controlling the control modules within other shelves and other components outside the shelves within the system through the first switch network.
